(19) United States
(12) Patent Application Publication
(10) Pub. No.: US 2011/0103109 A1
(43) Pub. Date: May 5, 2011

(54) AC POWER SOURCE APPARATUS

(75) Inventors: Toru Ashikaga, Saitama (JP); Kengo Kimura, Saitama (JP)

(73) Assignee: Sanken Electric Co., Ltd., Niiza-shi (JP)

(21) Appl. No.: 12/674,988

(22) PCT Filed: Sep. 10, 2008
(86) PCT No.: PCT/JP2008/066321

§ 371 Date: Feb. 24, 2010

(30) Foreign Application Priority Data
Sep. 27, 2007 (JP) 2007-251728

(51) Int. Cl. H02M 7/497

(52) U.S. Cl. 363/71

(57) ABSTRACT

An AC power source apparatus includes a first AC voltage generator having a first switch set, to output a first AC voltage having a positive-negative asymmetrical waveform by turning on/off the first switch set to a first end of a load; a second AC voltage generator having a second switch set, to output a second AC voltage having a positive-negative asymmetrical waveform and a phase difference of 180 degrees with respect to the first AC voltage by turning on/off the second switch set to a second end of the load; and a control circuit to turn on/off the first switch set, and by setting a phase difference of 180 degrees with respect to the turning on/off of the first switch set, turn on/off the second switch set. A voltage across the load is an AC voltage having a positive-negative symmetrical waveform.

### TECHNICAL FIELD

The present invention relates to an AC power source apparatus that converts a DC voltage into an AC voltage through a transformer and supplies the converted AC voltage to a load, and particularly, to a technique of supplying an AC voltage to a discharge lamp acting as a load and lighting the discharge lamp.

### BACKGROUND TECHNOLOGY

The AC power source apparatus is an apparatus configured to convert a DC voltage through a transformer into an AC voltage to drive a load. An example of the AC power source apparatus connected to a load is a discharge lamp lighting apparatus that provides an AC voltage to light a cold cathode fluorescent lamp acting as a load. The cold cathode fluorescent lamp (CCFL) is generally lighted by an AC power source with a voltage value of several hundreds to one thousand several hundreds of voltages and a frequency of several tens of kilohertz. There is a fluorescent lamp called an external electrode fluorescent lamp (EEFL). The external electrode fluorescent lamp and cold cathode fluorescent lamp are different in electrode structures and are substantially the same in the remaining configuration including light emission principles. Accordingly, AC power source apparatuses for lighting the external electrode fluorescent lamp and cold cathode fluorescent lamp are the same in principle. The following explanation is made in connection with the cold cathode fluorescent lamp (referred to as “discharge lamp”).

The discharge lamps and AC power source apparatuses are used for liquid crystal television sets, liquid crystal monitors, lighting units, liquid crystal displays, advertisement boards, and the like. The AC power source is required to have characteristics of (a) providing an AC voltage having a frequency of about 50 kHz and (b) providing a discharge lamp with an AC voltage having a positive-negative symmetrical waveform with respect to a neutral level.

In connection with the item (a), the frequency of a voltage applied to a discharge lamp is generally about 10 kHz to 100 kHz. This is determined by a user in consideration of various characteristics such as the brightness and efficiency of a discharge lamp and the brightness of a unit in which the discharge lamp is installed. Then, the AC power source apparatus is driven at or around the determined frequency. The frequency of the AC power source apparatus, therefore, is usually unable to set or change thereafter depending on convenience. Liquid crystal television sets, liquid crystal monitors, illuminating units, and the like are frequently operated at about 50 kHz, and therefore, the following explanation is made in connection with AC power source apparatuses of 50 kHz.

In connection with the item (b), a voltage to be applied to a discharge lamp must be an AC voltage having a positive-negative symmetrical waveform. The discharge lamp is a glass tube in which mercury, noble gas, and the like are sealed. The discharge lamp may emit light with DC voltage. However, the sealed mercury tends to localize to one side of the glass tube to gradually cause a brightness difference between ends of the discharge lamp. This greatly shortens the service life of the discharge lamp. For this, AC voltage is applied to the discharge lamp. Even the AC voltage will bias the mercury distribution if the voltage involves a difference between positive and negative waveforms. Accordingly, the AC voltage must have a positive-negative symmetrical waveform. Ideally, a sinusoidal wave or a trapezoidal wave is preferable. In practice, there are many systems that provide sinusoidal voltage.

A liquid crystal television set, for example, involves various signal systems such as video processing signals and voice processing signals. If the frequencies of these signals and an AC voltage driving frequency interfere with each other, images and voices will badly be affected. For this, the AC voltage driving frequency must keep a constant value that causes no interference.

FIG. 1 is a circuit diagram illustrating a discharge lamp lighting apparatus employing a non-resonant half-bridge circuit according to a related art. This discharge lamp lighting apparatus generates, from a DC voltage of a DC power source Vin, a rectangular voltage by switching switch elements Q1 and Q2 made of, for example, MOSFETs in response to gate signals Q1g and Q2g illustrated in FIG. 2. The rectangular voltage is filtered through a reactor L1 and a capacitor C2 into a positive-negative symmetrical sinusoidal voltage, which is converted by a transformer T1 into a required voltage value and is outputted as a voltage Vout from the capacitor C2. The positive-negative symmetrical sinusoidal voltage Vout is easily provided with the two switch elements, and therefore, this apparatus is advantageous in cost.

Operation of the discharge lamp lighting apparatus will be explained with reference to a timing chart illustrated in FIG. 2. From time t11 to time t12, the switch element Q1 turns on to charge a capacitor C1 and pass a current through a primary winding P1 of the transformer T1. From time t13 to time t14, the switch element Q2 turns on to discharge the capacitor C1 and pass a current in a reverse direction through the primary winding P1 of the transformer T1. As a result, an AC current passes through the primary winding P1.

In a period from time t12 to time t13 and a period from time t14 and time t15, a series-parallel resonant operation by a capacitance component of the capacitors C1 and C2 and an inductance component of the primary winding P1 mainly oscillates currents passing through the primary winding P1 and creates periods during which diodes D1 and D2 become conductive. Negative currents in current waveforms Q1i and Q2i are currents passing through the diodes D1 and D2. Paying attention to time t11, the switch element Q1 turns on when the diode D2 is conductive. A diode has a cumulative effect, and therefore, passes a current in a reverse direction for a short period. Namely, a short-circuit current passes from the switch element Q1 to the switch element Q2. The amount and time of the short-circuit current are mainly determined by the reverse recovery time characteristic of the diode D2. If this time of the diode is short, the short-circuit current will be small. However, it will not become zero in principle.

Namely, as soon as the switch element Q1 turns on at time t11, a switching loss occurs.

Similarly at time t13, the reverse recovery time characteristic of the diode D1 causes a switching loss as soon as the switch element Q2 turns on. Passing the short-circuit current is disadvantageous in noise. Namely, the switch elements Q1 and Q2 carry out a hard switching operation.

FIG. 3 is a circuit diagram illustrating a discharge lamp lighting apparatus employing a resonant full-bridge circuit according to a related art. This discharge lamp lighting apparatus generates, from a DC voltage of a DC power source Vin, a rectangular voltage by switching switch elements Q1 to Q4 in response to gate signals Q1g to Q4g illustrated in FIG. 4. The rectangular voltage is filtered through a reactor L1 and a capacitor C2 into a positive-negative symmetrical sinusoidal voltage, which is converted by a transformer T1 into a required voltage value and is outputted as a voltage Vout from the capacitor C2.

As illustrated in a timing chart of FIG. 4, the switch elements Q1 and Q2 complementarily turn on/off according to the gate signals Q1g and Q2g having a predetermined dead time. The switch elements Q3 and Q4 complementarily turn on/off according to the gate signals Q3g and Q4g having a predetermined dead time. The gate signals Q1g and Q2g for a first arm consisting of the switch elements Q1 and Q2 have a phase difference of 180 degrees with respect to the gate signals Q3g and Q4g for a second arm consisting of the switch elements Q3 and Q4. In FIG. 4, Q1v to Q4v are drain-source voltages of the switch elements Q1 to Q4, Q1i to Q4i are drain currents of the switch elements Q1 to Q4, VT is a voltage across a series circuit including a primary winding P1 and the reactor L1, and Vs1 is a voltage across a secondary winding S1.

The circuit illustrated in FIG. 3 carries out a resonant operation according to the timing chart of FIG. 4, and therefore, no switching loss occurs when any switch element turns on. The circuit provides a positive-negative symmetrical sinusoidal voltage as an output voltage, and therefore, is used when efficiency or noise characteristic must be emphasized. The circuit, however, is disadvantageous in cost because it needs four switch elements.

FIG. 5 illustrates an arrangement example 1 of a discharge lamp lighting apparatus according to a related art. FIG. 5 is a back view of the discharge lamp lighting apparatus for a liquid crystal television set. On the surface side of a panel 13a, there are arranged discharge lamps 7-1 to 7-n side by side. An inverter board 11a is arranged on the right side of the panel 13a and is connected to the discharge lamps 7-1 to 7-n through connectors 15a and 15b and wires 9a and 9b. FIG. 6 illustrates a circuit example 1 of the arrangement example 1 of the discharge lamp lighting apparatus of FIG. 5.

The circuit example 1 of FIG. 6 is inapplicable when the size of the panel, i.e., the length of the discharge lamps is longer than a certain length. This is because a discharge lamp increases its impedance as the length thereof extends, and then, a transformer T1 must provide a higher output voltage. As the output voltage increases, the transformer must employ a higher insulating structure and safety measure, to increase the size and cost thereof. Generally, an output voltage of about 2000 to 2500 Vrms is the limit.

For a long discharge lamp, a discharge lamp lighting apparatus illustrated in FIG. 7 is usable. This apparatus operates transformers T1 and T2 in opposite phases, to halve an output voltage from each transformer. FIG. 8 illustrates an arrangement example 2 for a circuit example 2, i.e., the discharge lamp lighting apparatus of FIG. 7. In FIG. 8, an output wire of a secondary wiring S2 of the transformer T2 is long. The output wire involves a high voltage and high frequency, and therefore, increases a leakage current and deteriorates efficiency as the output wire extends. It also creates noise.

FIG. 9 illustrates a circuit example 3 that solves the problem of the arrangement example 2 of FIG. 8. A discharge lamp lighting apparatus illustrated in FIG. 9 arranges inverter boards 11d and 11e at each end of a panel 13a, provides an AC voltage from an AC power source apparatus on the inverter board 11d and an AC voltage from an AC power source apparatus on the inverter board 11e with a phase difference of 180 degrees, and applies the AC voltages to ends of discharge lamps 7-1 to 7-n. A control circuit 10b switches switch elements Q1 to Q4 to output a positive-negative symmetrical sinusoidal voltage from a secondary winding S1 of a transformer T1. A control circuit 10c switches switch elements Q5 to Q8 with a phase difference of 180 degrees with respect to the switch elements Q1 to Q4 and outputs a positive-negative symmetrical sinusoidal voltage from a secondary winding S2 of a transformer T2. This minimizes high-voltage, high-frequency wires, and therefore, is applicable to, in particular, large liquid crystal panels.

Another related art is disclosed in, for example, Japanese Unexamined Patent Application Publication No. H08-162280.

### DISCLOSURE OF INVENTION

The circuit example 3 of FIG. 9, however, needs two AC power source apparatuses, and therefore, must have eight switch elements when adopting a full-bridge configuration. It may employ a half-bridge configuration to use four switch elements. This, however, must achieve the hard switching operation mentioned above, and therefore, is disadvantageous in switching loss and noise. The circuit example 3 illustrated in FIG. 9 employs the two control circuits 10b and 10c that must be synchronized with each other. Increasing the number of control circuits results in increasing costs.

The present invention provides an AC power source apparatus capable of reducing the number of switch elements and minimizing the switching loss and noise of the switch elements.

According to a first technical aspect of the present invention, the AC power source apparatus includes a first AC voltage generation circuit having a first switch circuit, to generate, from a DC voltage of a first DC power source, a first AC voltage having a positive-negative asymmetrical waveform by turning on/off the first switch circuit and output the first AC voltage to a first end of a load; a second AC voltage generation circuit having a second switch circuit, to generate, from the DC voltage of the first DC power source or a DC voltage of a second DC power source, a second AC voltage having a positive-negative asymmetrical waveform and a phase difference of 180 degrees with respect to the first AC voltage by turning on/off the second switch circuit and output the second AC voltage to a second end of the load; and a control circuit to turn on/off the first switch circuit, and by setting a phase difference of 180 degrees with respect to the turning on/off of the first switch circuit, turn on/off the second switch circuit. This aspect is characterized in that a voltage across the load is an AC voltage having a positive-negative symmetrical waveform.

According to a second technical aspect of the present invention, in the above-mentioned AC power source apparatus, the first AC voltage generation circuit includes a first transformer having a primary winding connected to the first switch circuit and a secondary winding to output an induced voltage as the first AC voltage; and the second AC voltage generation circuit includes a second transformer having a primary winding connected to the second switch circuit and a secondary winding to output an induced voltage as the second AC voltage.

According to a third technical aspect of the present invention, in the above-mentioned AC power source apparatus, the first AC voltage generation circuit includes a first capacitor connected between the secondary winding of the first transformer and the first end of the load; and the second AC voltage generation circuit includes a second capacitor connected between the secondary winding of the second transformer and the second end of the load. According to a fourth technical aspect of the present invention that is based on the second technical aspect, the first AC voltage generation circuit includes a leakage inductance of the primary and secondary windings of the first transformer between the secondary winding of the first transformer and the first end of the load; and the second AC voltage generation circuit includes a leakage inductance of the primary and secondary windings of the second transformer between the secondary winding of the second transformer and the second end of the load.

According to a fifth technical aspect of the present invention that is based on the second technical aspect, the first AC voltage generation circuit includes a first winding connected between the secondary winding of the first transformer and the first end of the load; and the second AC voltage generation circuit includes a second winding connected between the secondary winding of the second transformer and the second end of the load.

### BRIEF DESCRIPTION OF DRAWINGS

FIG. 1 is a circuit diagram illustrating a discharge lamp lighting apparatus employing a non-resonant half-bridge circuit according to a related art.

FIG. 2 is a timing chart illustrating various parts of the discharge lamp lighting apparatus of FIG. 1.

FIG. 3 is a circuit diagram illustrating a discharge lamp lighting apparatus employing a resonant full-bridge circuit according to a related art.

FIG. 4 is a timing chart illustrating various parts of the discharge lamp lighting apparatus of FIG. 3.

FIG. 5 is a view illustrating an arrangement example of a discharge lamp lighting apparatus according to a related art.

FIG. 6 is a view illustrating a circuit example 1 of the arrangement example 1 of the discharge lamp lighting apparatus of FIG. 5.

FIG. 7 is a view illustrating a circuit example 2 of a discharge lamp lighting apparatus according to a related art.

FIG. 8 is a view illustrating an arrangement example 2 of the circuit example 2 of the discharge lamp lighting apparatus of FIG. 7.

FIG. 9 is a view illustrating a circuit example 3 of a discharge lamp lighting apparatus according to a related art.

FIG. 10 is a view illustrating a discharge lamp lighting apparatus according to Embodiment 1 of the present invention.

FIG. 11 is a timing chart illustrating various parts of the discharge lamp lighting apparatus according to Embodiment 1 of the present invention.

FIG. 12A is a timing chart illustrating various parts of the discharge lamp lighting apparatus according to Embodiment 1 when supplying small power.

FIG. 12B is a timing chart illustrating the various parts of the discharge lamp lighting apparatus according to Embodiment 1 when supplying large power.

FIG. 13 is a view illustrating a discharge lamp lighting apparatus according to Embodiment 2 of the present invention.

FIG. 14 is a view illustrating a discharge lamp lighting apparatus according to Embodiment 3 of the present invention.

FIG. 15 is a view illustrating a discharge lamp lighting apparatus according to Embodiment 4 of the present invention.

FIG. 16 is a timing chart illustrating various parts of the discharge lamp lighting apparatus according to Embodiment 4 of the present invention.

FIG. 17 is a view illustrating a discharge lamp lighting apparatus according to Embodiment 5 of the present invention.

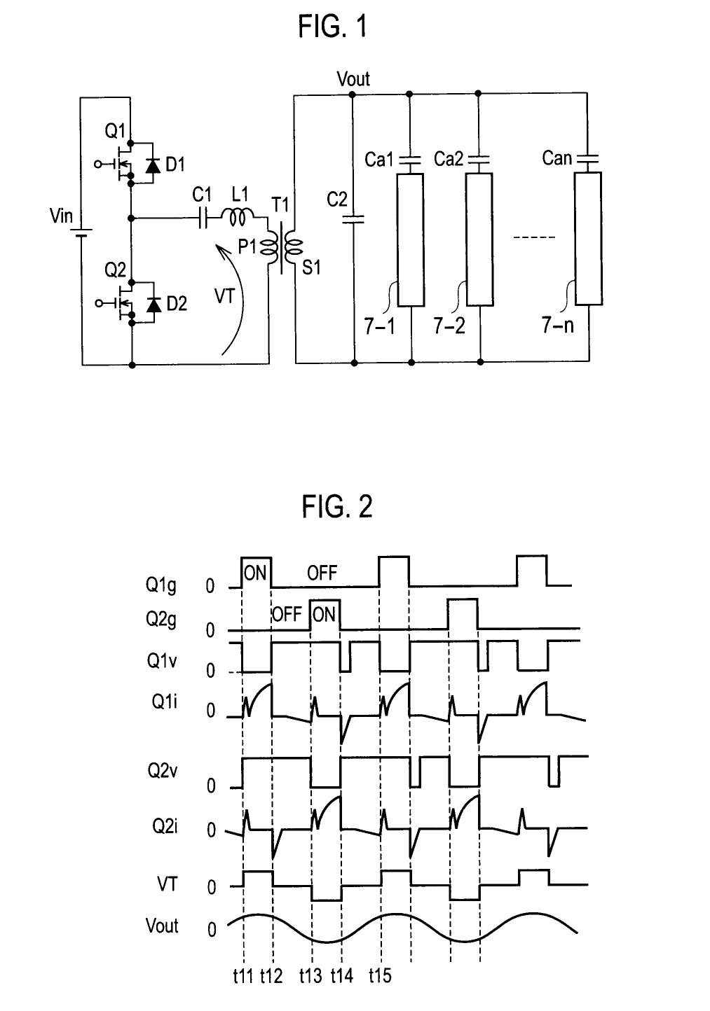

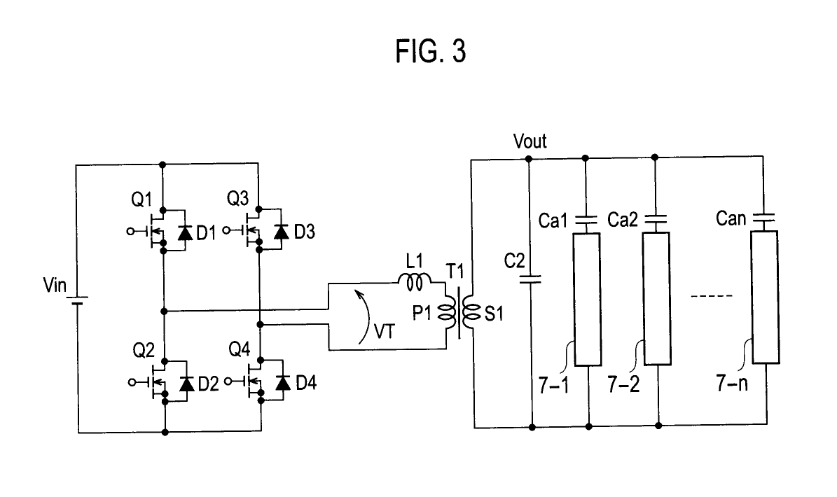

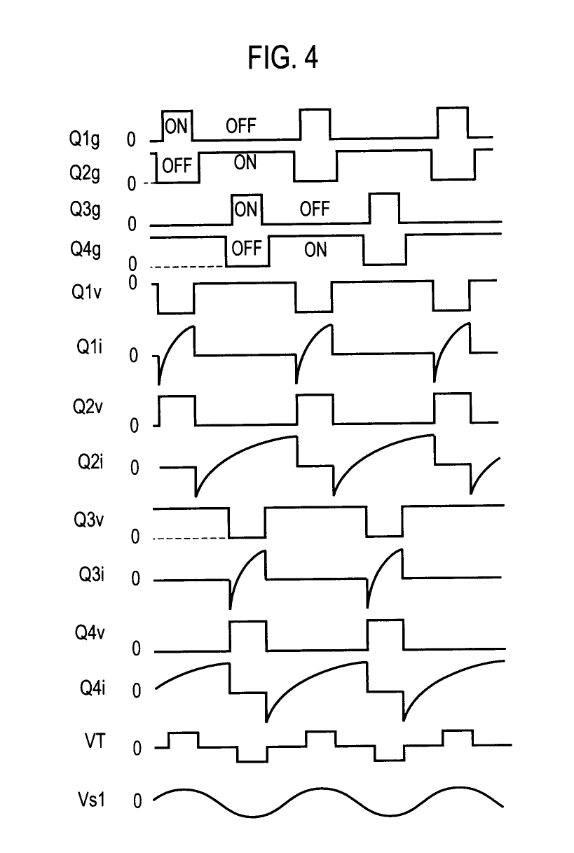

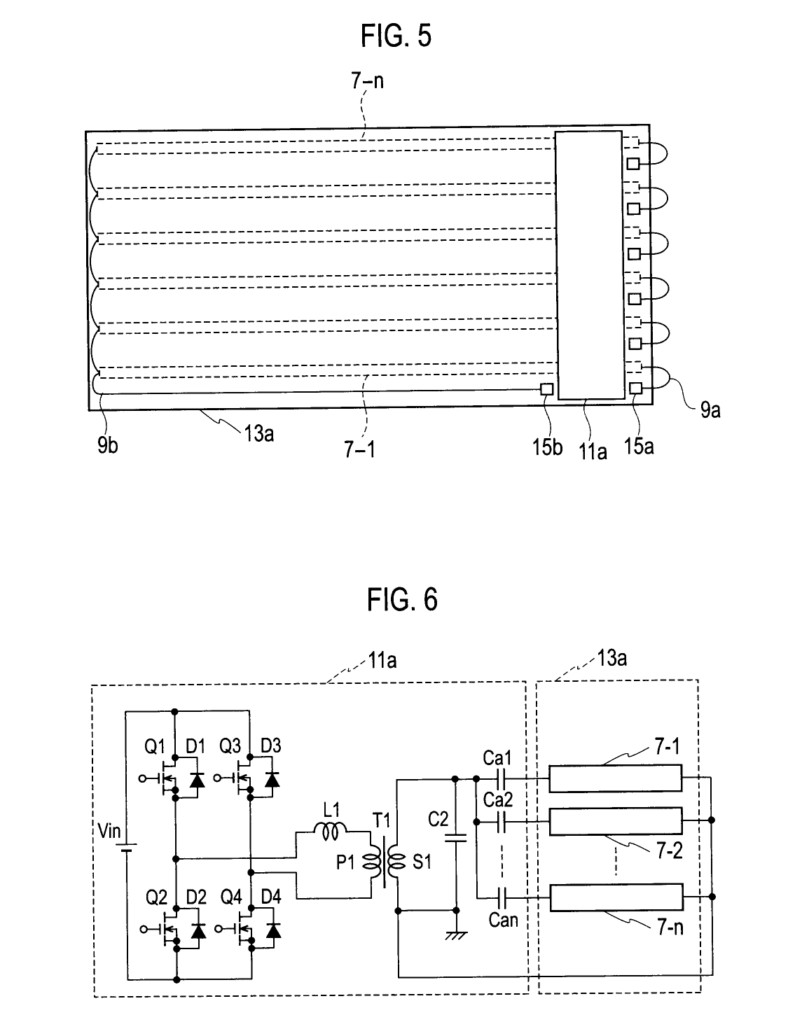

### BEST MODE OF IMPLEMENTING INVENTION

AC power source apparatuses according to embodiments of the present invention will be explained in detail with reference to the drawings. In the following explanation, each AC power source apparatuses of the present invention is applied to a discharge lamp lighting apparatus. In the discharge lamp lighting apparatus, the AC power source apparatus of the present invention is connected to a discharge lamp acting as a load.

In the embodiments, the load is a discharge lamp. The load is not limited to a discharge lamp. The AC power source apparatuses of the present invention are applicable to any other load.

### Embodiment 1

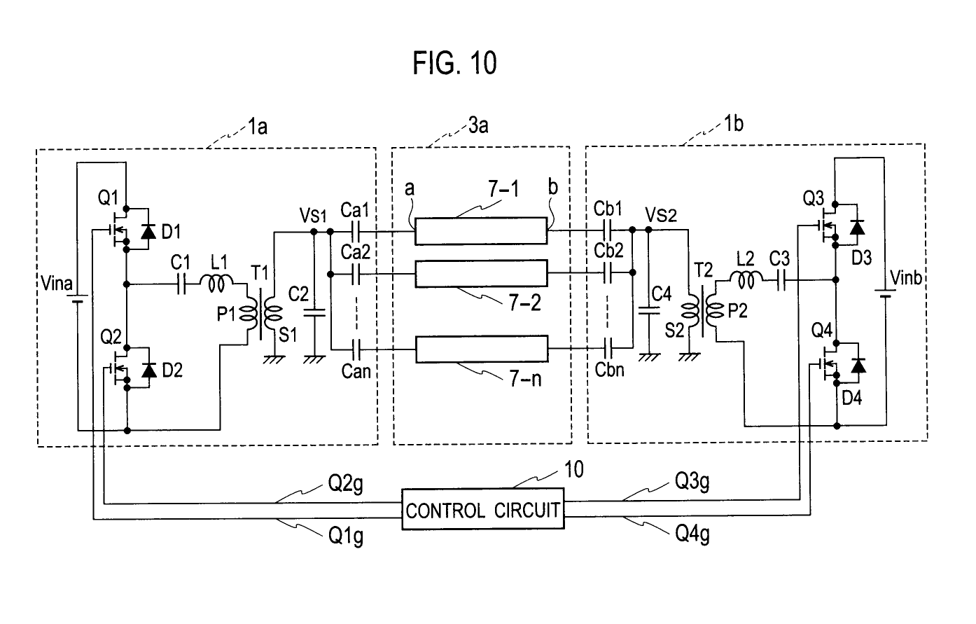

FIG. 10 is a view illustrating a configuration of a discharge lamp lighting apparatus according to Embodiment 1 of the present invention. In FIG. 10, inverter boards la and 1b are arranged at each end of a panel 3a.

The inverter board la has a first AC voltage generation circuit that turns on/off switch elements Q1 and Q2 (a first set of switches) to convert a DC voltage of a DC power source Vina into a first AC voltage having a positive-negative asymmetrical waveform with respect to a reference level and output the first AC voltage to first ends of discharge lamps 7-1 to 7-n. The inverter board 1b has a second AC voltage generation circuit that turns on/off switch elements Q3 and Q4 (a second set of switches) to convert a DC voltage of a DC power source Vinb into a second AC voltage having a positive-negative asymmetrical waveform and a phase difference of 180 degrees with respect to the first AC voltage and output the second AC voltage to second ends of the discharge lamps 7-1 to 7-n.

In the first AC voltage generation circuit, both ends of the DC power source Vina are connected to a series circuit including the switch element Q1 made of, for example, a MOSFET and the switch element Q2 made of, for example, a MOSFET. Connected between the drain and source of the switch element Q2 is a series circuit including a capacitor C1, a reactor L1, and a primary winding P1 of a transformer T1 (a first transformer). Both ends of a secondary winding S1 of the transformer T1 are connected in parallel with a capacitor C2. A connection point (on the non-ground potential side) between the secondary winding S1 of the transformer T1 and the capacitor C2 is connected to commonly connected first ends of ballast capacitors Ca1 to Can (a first capacitor). Second ends of the ballast capacitors Ca1 to Can are connected to the first ends (a-side) of the discharge lamps 7-1 to 7-n. The reactor L1 and capacitor C2 are filters to pass an AC voltage having a positive-negative asymmetrical waveform to the capacitor C2.

In the second AC voltage generation circuit, both ends of the DC power source Vinb are connected to a series circuit including the switch element Q3 made of, for example, a MOSFET and the switch element Q4 made of, for example, a MOSFET. Connected between the drain and source of the switch element Q4 is a series circuit including a capacitor C3, a reactor L2, and a primary winding P2 of a transformer T2 (a second transformer). Both ends of a secondary winding S2 of the transformer T2 are connected in parallel with a capacitor C4. A connection point (on the non-ground potential side) between the secondary winding S2 of the transformer T2 and the capacitor C4 is connected to commonly connected first ends of ballast capacitors Cb1 to Cbn (a second capacitor). Second ends of the ballast capacitors Cb1 to Cbn are connected to the second ends (b-side) of the discharge lamps 7-1 to 7-n. The reactor L2 and capacitor C4 are filters to pass an AC voltage having a positive-negative asymmetrical waveform to the capacitor C4.

Diodes D1, D2, D3, and D4 between the drains and sources of the switch elements Q1, Q2, Q3, and Q4 may be parasitic diodes of the switch elements Q1, Q2, Q3, and Q4. The capacitors C2 and C4 may be parasitic capacitances of, for example, wiring. In this case, the capacitors C2 and C4 may be removed or reduced in size. The DC power sources may be reduced to one.

A control circuit 10 complementarily turns on/off the switch elements Q1 and Q2 (a first arm) according to gate signals Q1g and Q2g and complementarily turns on/off the switch elements Q3 and Q4 (a second arm) according to gate signals Q3g and Q3g with a phase difference of 180 degrees with respect to the turning on/off of the switch elements Q1 and Q2.

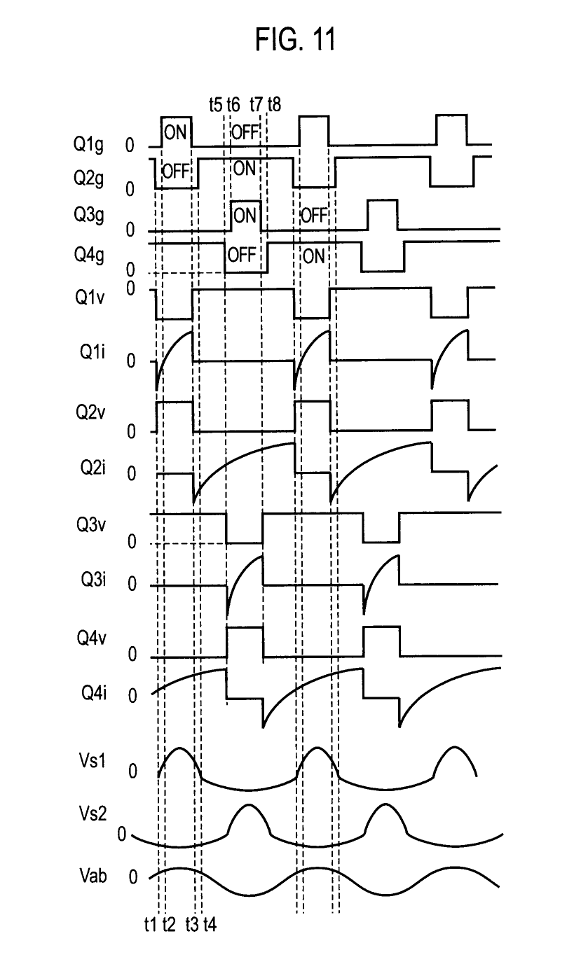

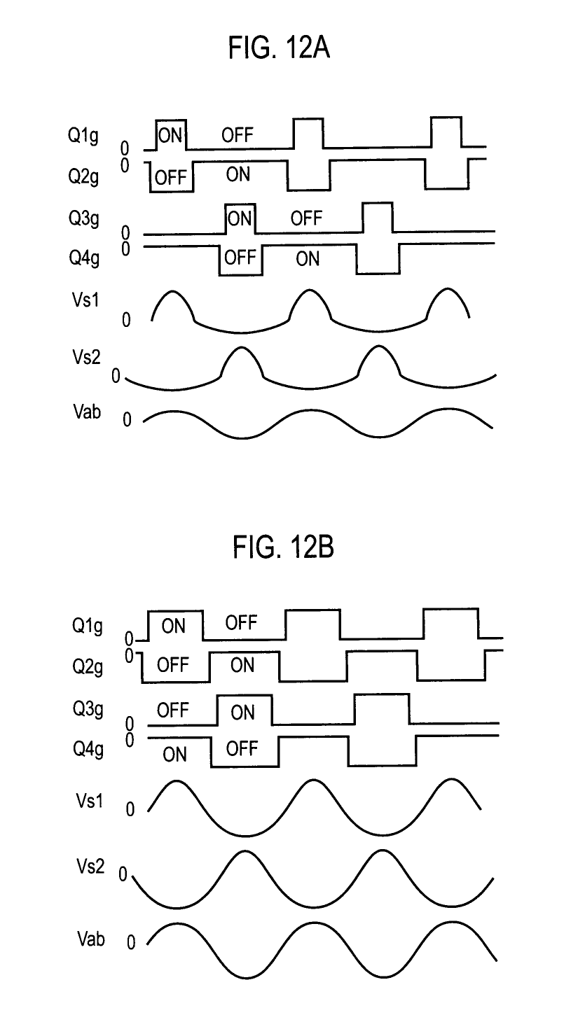

Operation of the discharge lamp lighting apparatus of Embodiment 1 having the above-mentioned configuration will be explained with reference to timing charts of FIGS. 11, 12A, and 12B.

In FIGS. 11, 12A, and 12B, Q1v to Q4v are drain-source voltages of the switch elements Q1 to Q4, Q1i to Q4i are drain currents of the switch elements Q1 to Q4, Vs1 is a voltage across the secondary winding S1, Vs2 is a voltage across the secondary winding S2, and Vab is a voltage across the discharge lamps 7-1 to 7-n.

First, the first arm including the switch elements Q1 and Q2 will be explained. The gate signals Q1g and Q2g turn on the switch element Q1, turn off the switch element Q2, turn off the switch element Q1, and turn on the switch element Q2. Not to simultaneously turn on the switch elements Q1 and Q2, there is a dead time during which both the switch elements are OFF.

The control circuit 10 controls ON duties of the switch elements Q1 and Q2, to thereby control power to be supplied to the discharge lamps 7-1 to 7-n. Comparing FIGS. 12A and 12B with each other, it is understood that widening the ON duty of the switch element Q1 increases power supplied to the discharge lamps 7-1 to 7-n and shortens the ON duty of the switch element Q2 because the switch element Q2 is OFF when the switch element Q1 is ON. Operation of the switch elements Q3 and Q4 is the same as that of the switch elements Q1 and Q2.

Operation of the discharge lamp lighting apparatus illustrated in FIG. 10 will be explained in detail with reference to the timing chart of FIG. 11.

At time t2, the switch element Q1 receives the gate signal Q1g. At time t1, the gate signal Q2g turns off the switch element Q2, the diode D1 becomes conductive, and the drain-source voltage of the switch element Q1 becomes substantially zero (precisely, it will not be zeroed due to a forward voltage component of the diode D1).

The current of the diode D1 decreases thereafter. Before this current becomes zero, i.e., when the drain-source voltage of the switch element Q1 is substantially zero, the switch element Q1 receives the gate signal Q1g at time t2. Accordingly, no switching loss occurs at this time. Namely, there is no switching loss when the switch element Q1 turns on. Also, there is no short-circuit current.

The switch element Q2 is the same as the switch element Q1. At time t3, the switch element Q1 turns off and the diode D2 becomes conductive. As a result, the drain-source voltage of the switch element Q2 is nearly zero (precisely, it will not be zeroed due to a forward voltage component of the diode D2).

The current of the diode D2 decreases thereafter. Before this current becomes zero, i.e., when the drain-source voltage of the switch element Q2 is nearly zero, the switch element Q2 receives the gate signal Q2g at time t4. Accordingly, no switching loss occurs at this time. Namely, there is no switching loss when the switch element Q2 turns on. Also, there is no short-circuit current.

The switch element Q3 turns on/off in response to the gate signal Q3g like the on/off operation of the switch element Q1 with a phase difference of 180 degrees with respect to the on/off operation of the switch element Q1. The switch element Q4 turns on/off in response to the gate signal Q4g like the on/off operation of the switch element Q2 with a phase difference of 180 degrees with respect to the on/off operation of the switch element Q2.

In this way, the control circuit 10 drives the switch elements Q1 to Q4 at the timing illustrated in FIG. 11, so that the first arm of the switch elements Q1 and Q2 and the second arm of the switch elements Q3 and Q4 conduct a soft switching operation when turned on, to decrease switching losses.

The circuit illustrated in FIG. 10 carries out a resonant operation as illustrated in the timing chart of FIG. 11, and therefore, the secondary windings S1 and S2 of the transformers T1 and T2 output positive-negative asymmetrical voltage waveforms. In FIG. 11, the secondary winding voltages Vs1 and Vs2 of the transformers T1 and T2 have positive-negative asymmetrical voltage waveforms with respect to a reference level (depicted by “0”).

The first arm of the switch elements Q1 and Q2 and the second arm of the switch elements Q3 and Q4 operate with a phase difference of 180 degrees, and therefore, the secondary winding voltages Vs1 and Vs2 have similar shapes with the phase difference of 180 degrees.

The secondary winding voltage Vs1 is applied to the first ends of the discharge lamps 7-1 to 7-n and the secondary winding voltage Vs2 is applied to the second ends of the discharge lamps 7-1 to 7-n. Then, a voltage across the discharge lamps 7-1 to 7-n is equal to a difference between the secondary voltages Vs1 and Vs2. Namely, the voltage Vab across the discharge lamps 7-1 to 7-n has a positive-negative symmetrical waveform to a reference level (depicted by “0”). Since the voltage across the discharge lamps 7-1 to 7-n has a positive-negative symmetrical waveform to the reference level, no deviation of mercury or no reduction in service life will occur.

In this way, the discharge lamp lighting apparatus of Embodiment 1 carries out a resonant operation with the switch elements Q1 and Q2 and the switch elements Q3 and Q4, to apply a positive-negative symmetrical sinusoidal voltage to both ends of the discharge lamps and shorten high-voltage, high-frequency wiring. This results in reducing the number of switch elements, minimizing the switching loss and noise of the switch elements, and scaling back control circuits.

The control circuit 10 controls the ON duties of the switch elements Q1 to Q4, to adjust power to the discharge lamps 7-1 to 7-n. The control circuit 10 is capable of controlling the power, current, and brightness of the discharge lamps 7-1 to 7-n according to currents to the discharge lamps, currents to the windings of the transformers T1 and T2, and currents to the switch elements Q1 to Q4.

The related arts (FIGS. 6, 7, and 9) and Embodiment 1 will be compared with each other in terms of cost, efficiency, and noise.

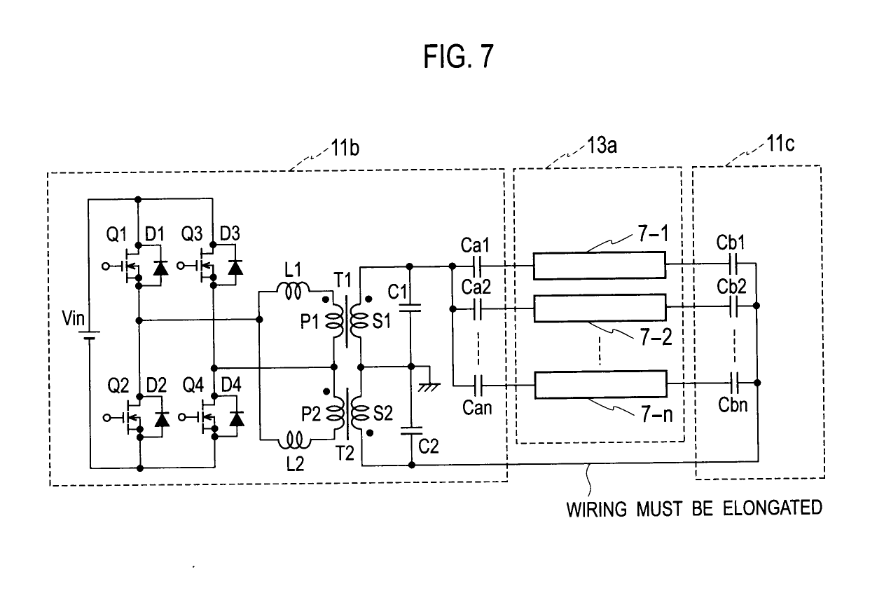

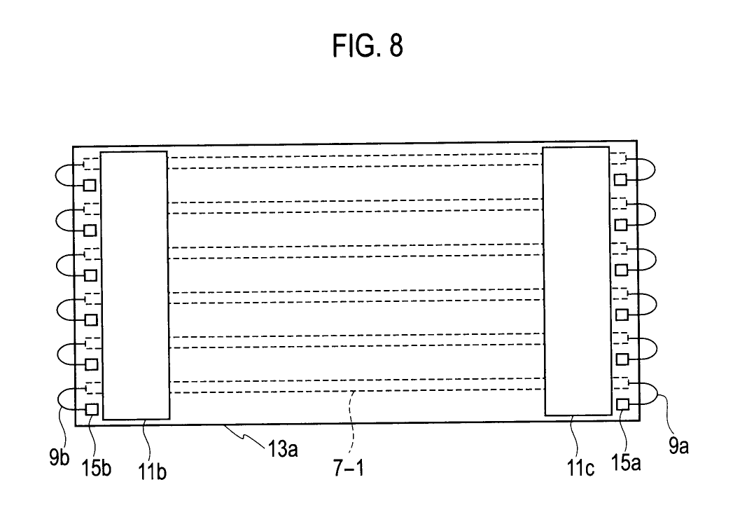

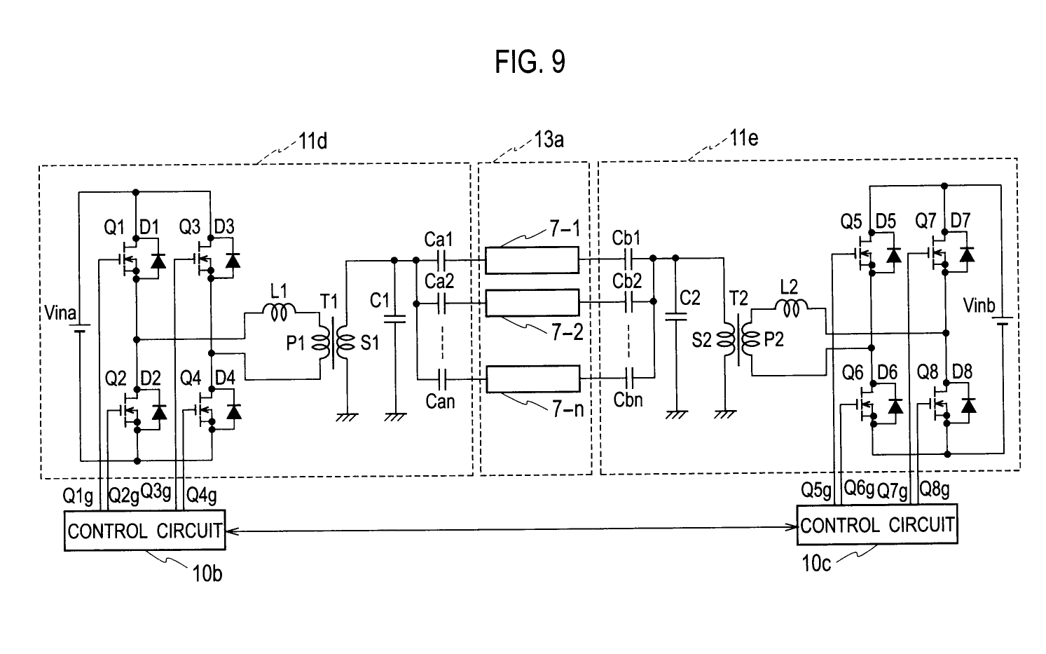

The related art of FIG. 6 is good in each term. It, however, is applicable only to a small-sized liquid crystal television panel (with short discharge lamps). The related arts of FIGS. 7 and 9 are applicable to large-sized panels (with long discharge lamps). They, however, involve long high-voltage wiring and a poor noise characteristic. The related art of FIG. 9 is disadvantageous in cost because it employs eight switch elements.

On the other hand, Embodiment 1 shows, even when applied to a large-sized liquid crystal television panel, good characteristics like the related art of FIG. 6 in terms of cost, efficiency, and noise.

### Embodiment 2

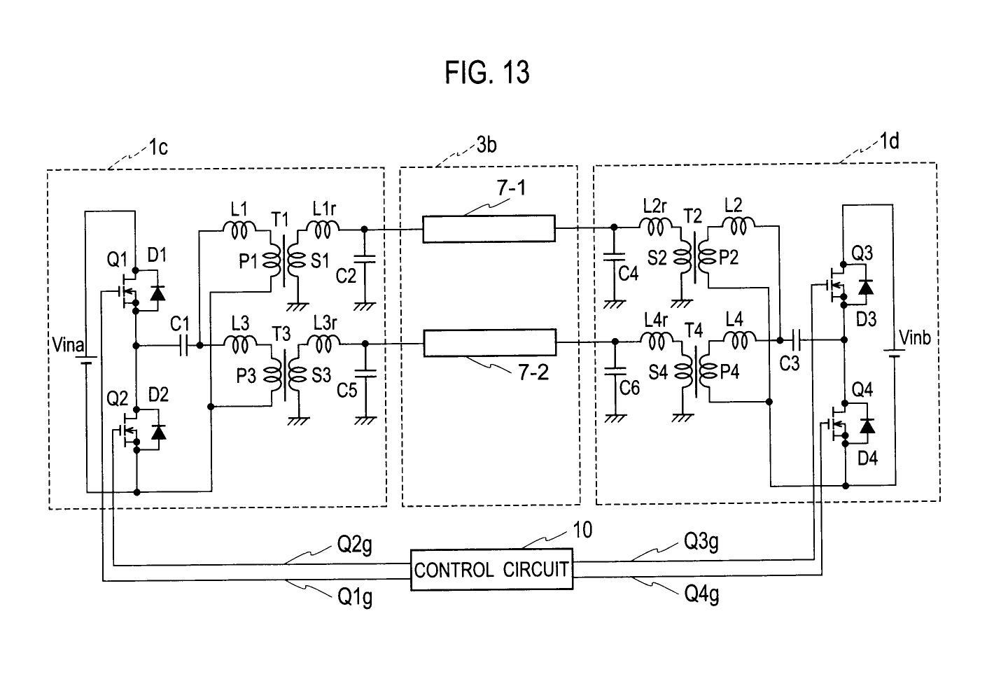

FIG. 13 is a view illustrating a configuration of a discharge lamp lighting apparatus according to Embodiment 2 of the present invention. In FIG. 13, inverter boards 1c and 1d are arranged at each end of a panel 3b. The inverter board 1c has a first AC voltage generation circuit to output a first AC voltage having a positive-negative asymmetrical waveform to first ends of discharge lamps 7-1 and 7-2. The inverter board 1d has a second AC voltage generation circuit to output a second AC voltage having a positive-negative asymmetrical waveform to second ends of the discharge lamps 7-1 and 7-2.

In the first AC voltage generation circuit, connected between the drain and source of a switch element Q2 is a series circuit including a capacitor C1, a reactor L1, and a primary winding P1 of a transformer T1. L1r connected in series with a secondary winding S1 of the transformer T1 is a leakage inductance between the primary winding P1 and secondary winding S1 of the transformer T1. Both ends of a series circuit including the secondary winding S1 and leakage inductance L1r of the transformer T1 are connected in parallel with a capacitor C2. A connection point between the leakage inductance L1r and the capacitor C2 is connected to the first end of the discharge lamp 7-1.

Both ends of a series circuit including the reactor L1 and the primary winding P1 of the transformer T1 are connected to a series circuit including a reactor L3 and a primary winding P3 of a transformer T3. L3r connected in series with a secondary winding S3 of the transformer T3 is a leakage inductance between the primary winding P3 and secondary winding S3 of the transformer T3. Both ends of a series circuit including the secondary winding S3 and leakage inductance L3r of the transformer T3 are connected in parallel with a capacitor C5. A connection point between the leakage inductance L3r and the capacitor C5 is connected to the first end of the discharge lamp 7-2.

In the second AC voltage generation circuit, connected between the drain and source of a switch element Q4 is a series circuit including a capacitor C3, a reactor L2, and a primary winding P2 of a transformer T2. L2r connected in series with a secondary winding S2 of the transformer T2 is a leakage inductance between the primary winding P2 and secondary winding S2 of the transformer T2. Both ends of a series circuit including the secondary winding S2 and leakage inductance L2r of the transformer T2 are connected in parallel with a capacitor C4. A connection point between the leakage inductance L2r and the capacitor C4 is connected to the second end of the discharge lamp 7-1.

Both ends of a series circuit including the reactor L2 and the primary winding P2 of the transformer T2 are connected to a series circuit including a reactor L4 and a primary winding P4 of a transformer T4. L4r connected in series with a secondary winding S4 of the transformer T4 is a leakage inductance between the primary winding P4 and secondary winding S4 of the transformer T4. Both ends of a series circuit including the secondary winding S4 and leakage inductance L4r of the transformer T4 are connected in parallel with a capacitor C6. A connection point between the leakage inductance L4r and the capacitor C6 is connected to the second end of the discharge lamp 7-2. The capacitors C2, C4, C5, and C6 may be parasitic capacitances of, for example, wiring. In this case, the capacitors C2, C4, C5, and C6 may be removed or reduced in size. DC power sources may be reduced to one.

Control operation of the switch elements Q1 to Q4 conducted by a control circuit 10 and operation of the transformers T1 to T4 are similar to those of Embodiment 1.

The discharge lamp lighting apparatus of Embodiment 1 employs the ballast capacitors Ca1 to Can and Cb1 to Cbn as ballast elements for supplying power to discharge lamps. On the other hand, Embodiment 2 is characterized in that it employs as ballast elements the leakage inductances L1r to L4r of the transformers T1 to T4 and the inductance components of the reactors L1 to L4. Further, a larger number of discharge lamps may be lighted by increasing the numbers of the transformers and reactors.

### Embodiment 3

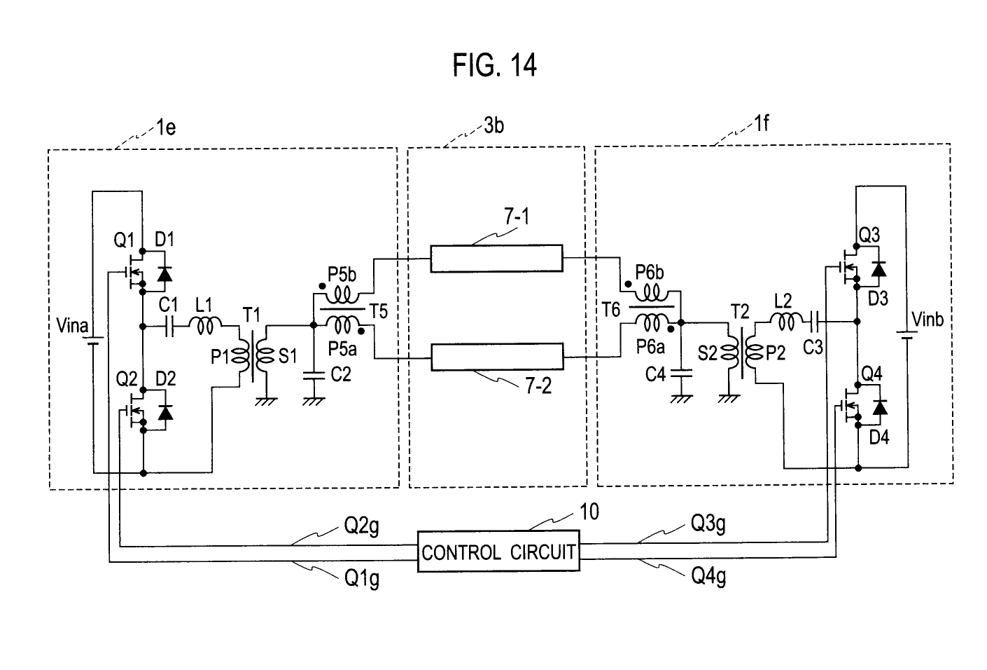

FIG. 14 is a view illustrating a configuration of a discharge lamp lighting apparatus according to Embodiment 3 of the present invention. In FIG. 14, inverter boards 1e and if are arranged at each end of a panel 3b.

The inverter board 1e illustrated in FIG. 14 employs, instead of the ballast capacitors Ca1 to Can of the inverter board la illustrated in FIG. 10, a transformer T5 (first winding) having a winding P5a and a winding P5b whose polarity is opposite to that of the winding P5a. A connection point between a secondary winding S1 of a transformer T1 and a capacitor C2 is connected to a first end of the winding P5a and a first end (depicted by a black dot) of the winding P5b. A second end of the winding P5b is connected to a first end of a discharge lamp 7-1 and a second end (depicted by a black dot) of the winding P5a is connected to a first end of a discharge lamp 7-2.

The inverter board if illustrated in FIG. 14 employs, instead of the ballast capacitors Cb1 to Cbn of the inverter board 1b illustrated in FIG. 10, a transformer T6 (second winding) having a winding P6a and a winding P6b whose polarity is opposite to that of the winding P6a. A connection point between a secondary winding S2 of a transformer T2 and a capacitor C4 is connected to a first end (depicted by a black dot) of the winding P6a and a first end of the winding P6b. A second end (depicted by a black dot) of the winding P6b is connected to a second end of the discharge lamp 7-1 and a second end of the winding P6a is connected to a second end of the discharge lamp 7-2. DC power sources may be reduced to one.

Control operation of switch elements Q1 to Q4 conducted by a control circuit 10 and operation of the transformers T1 and T2 are similar to those of Embodiment 1.

Embodiment 3 employs inductance components of the transformers T5 and T6 as ballast elements to supply power to the discharge lamps.

The windings P5a and P5b of the transformer T5 and the windings P6a and P6b of the transformer T6 are wound in directions to cancel magnetic flux of cores if currents to the discharge lamps 7-1 and 7-2 are equal to each other. In this case, inductance increases as a difference between the currents to the discharge lamps 7-1 and 7-2 becomes larger. This provides an effect of equalizing the current values of the discharge lamps 7-1 and 7-2. The number of the transformers may be increased to increase the number of discharge lamps to be lighted.

### Embodiment 4

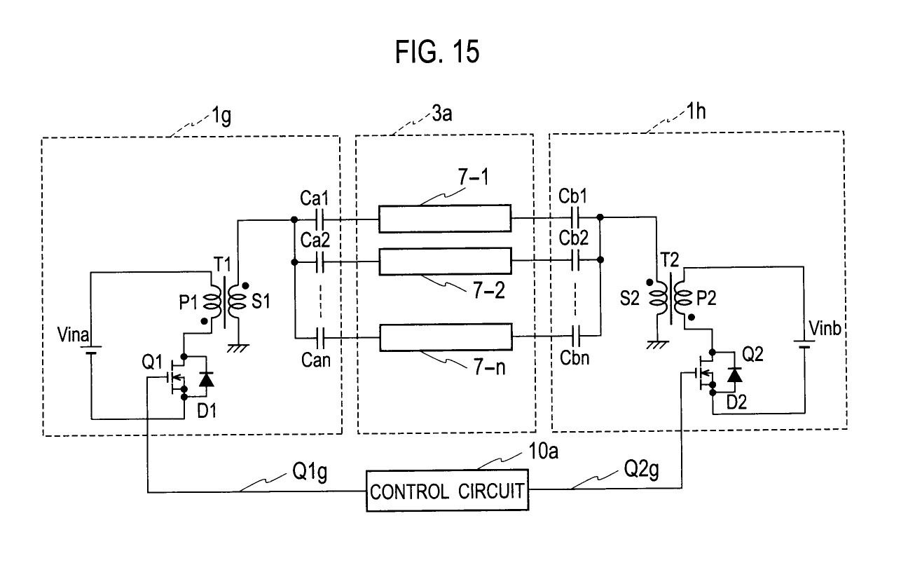

FIG. 15 is a view illustrating a configuration of a discharge lamp lighting apparatus according to Embodiment 4 of the present invention. In FIG. 15, inverter boards 1g and 1h are arranged at each end of a panel 3a. The inverter board 1g has a first AC voltage generation circuit that turns on/off a switch element Q1 (a first switch set) to convert a DC voltage of a DC power source Vina into a first AC voltage having a positive-negative asymmetrical waveform and output the first AC voltage to first ends of discharge lamps 7-1 to 7-n. The inverter board 1h has a second AC voltage generation circuit that turns on/off a switch element Q2 (a second switch set) to convert a DC voltage of a DC power source Vinb into a second AC voltage having a positive-negative asymmetrical waveform and a phase difference of 180 degrees with respect to the first AC voltage and output the second AC voltage to second ends of the discharge lamps 7-1 to 7-n.

In the first AC voltage generation circuit, both ends of the DC power source Vina are connected to a series circuit including a primary winding P1 of a transformer T1 and the switch element Q1 made of, for example, a MOSFET. A first end (depicted by a black dot) of a secondary winding S1 of the transformer T1 is connected to commonly connected first ends of ballast capacitors Ca1 to Can. Second ends of the ballast capacitors Ca1 to Can are connected to the first ends of the discharge lamps 7-1 to 7-n.

In the second AC voltage generation circuit, both ends of the DC power source Vinb are connected to a series circuit including a primary winding P2 of a transformer T2 and the switch element Q2 made of, for example, a MOSFET. A first end (depicted by a black dot) of a secondary winding S2 of the transformer T2 is connected to commonly connected first ends of ballast capacitors Cb1 to Cbn. Second ends of the ballast capacitors Cb1 to Cbn are connected to the second ends of the discharge lamps 7-1 to 7-n. The DC power sources may be reduced to one.

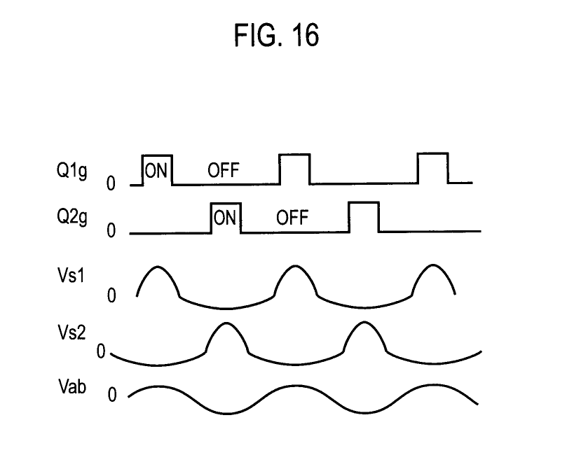

A control circuit 10a turns on/off the switch element Q1 according to a gate signal Q1g illustrated in FIG. 16 and turns on/off the switch element Q2 according to a gate signal Q2g with a phase difference of 180 degrees with respect to the turning on/off of the switch element Q1.

Embodiment 4 operates like Embodiment 1 and provides an effect similar to that of Embodiment 1.

### Embodiment 5

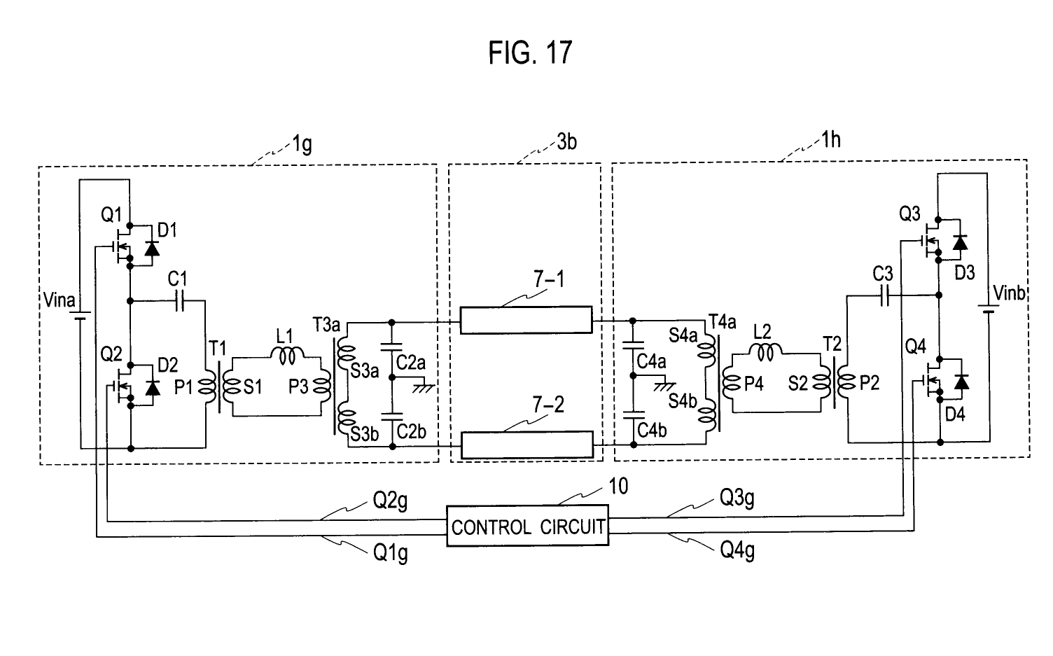

FIG. 17 is a view illustrating a configuration of a discharge lamp lighting apparatus according to Embodiment 5 of the present invention. Embodiment 1 illustrated in FIG. 10 generates high voltages at the secondary windings S1 and S2 of the transformers T1 and T2. If the transformers T1 and T2 must be insulated from each other, the transformers T1 and T2 must satisfy conditions such as an insulating distance specified by various safety standards. These conditions become severer as the voltages of the secondary windings S1 and S2 of the transformers T1 and T2 become higher, to increase the size and cost of the transformers T1 and T2.

To cope with the problem, Embodiment 5 connects both ends of a secondary winding S1 of a transformer T1 to a primary winding P3 of a step-up transformer T3a through a reactor L1, connects a first end of a secondary winding S3a of the step-up transformer T3a to a first end of a discharge lamp 7-1, and connects a first end of a secondary winding S3b of the step-up transformer T3a to a first end of a discharge lamp 7-2. Both ends of a series circuit including the secondary windings S3a and S3b are connected to a series circuit including capacitors C2a and C2b. A connection point between the capacitors C2a and C2b is grounded.

Both ends of a secondary winding S2 of a transformer T2 are connected through a reactor L2 to a primary winding P4 of a step-up transformer T4a, a first end of a secondary winding S4a of the step-up transformer T4a is connected to a second end of the discharge lamp 7-1, and a first end of a secondary winding S4b of the step-up transformer T4a is connected to a second end of the discharge lamp 7-2. Both ends of a series circuit including the secondary windings S4a and S4b are connected to a series circuit including capacitors C4a and C4b. A connection point between the capacitors C4a and C4b is grounded.

The remaining configuration of this embodiment is the same as that of Embodiment 1, and therefore, the same parts are represented with the same reference marks. This embodiment employs two discharge lamps. DC power sources may be reduced to one.

According to the above-mentioned configuration, the transformers T1 and T2 are insulated according to various safety standards and the step-up transformers T3a and T4a carry out step-up operation. As a result, voltages of the transformers T1 and T2 illustrated in FIG. 17 can be lower than voltages of the transformers T1 and T2 of Embodiment 1 illustrated in FIG. 10, to thereby avoid the above-mentioned problem.

The reactor L1 may be removed or reduced in size by using a leakage inductance of the transformer T1 or T3a. Similarly, the reactor L2 may be removed or reduced in size by using a leakage inductance of the transformer T2 or T4a. The numbers of the transformers T3a and T4a may be increased to increase the number of discharge lamps to be lighted.

The discharge lamp lighting apparatuses according to Embodiments 1 to 5 each handle a plurality of discharge lamps. Instead, they each may handle a single discharge lamp.

### EFFECT OF INVENTION

According to the present invention, the first AC voltage generation circuit outputs a first AC voltage having a positive-negative asymmetrical waveform to a first end of a load and the second AC voltage generation circuit outputs a second AC voltage having a positive-negative asymmetrical waveform to a second end of the load with a phase difference of 180 degrees with respect to the first AC voltage, so that an AC voltage across the load has a positive-negative symmetrical waveform. This configuration reduces the number of switch elements, decreases the switching loss and noise of the switch elements, and minimizes the number of control circuits.

### (United States Designation)

In connection with United States designation, this international patent application claims the benefit of priority under 35 U.S.C. 119(a) to Japanese Patent Application No. 2007-251728 filed on Sep. 27, 2007 whose disclosed contents are cited herein.

1. An AC power source apparatus comprising:
a first AC voltage generation circuit having a first switch set, configured to convert from a DC voltage of a first DC power source to a first AC voltage having a positive-negative asymmetrical waveform by turning on/off the first switch set and output the first AC voltage to a first end of a load;
a second AC voltage generation circuit having a second switch set, configured to convert from the DC voltage of the first DC power source or a DC voltage of a second DC power source to a second AC voltage having a positive-negative asymmetrical and a phase difference of 180 degrees with respect to the first AC voltage by turning on/off the second switch set and output the second AC voltage to a second end of the load; and
a control circuit configured to turn on/off the first switch set, and to turn on/off the second switch set with a phase difference of 180 degrees with respect to the turning on/off of the first switch set, wherein a voltage across the load is an AC voltage having a positive-negative symmetrical waveform.

2. The AC power source apparatus as set forth in claim 1, wherein:
the first AC voltage generation circuit includes a first transformer having a primary winding connected to the first switch set and a secondary winding to output an induced voltage as the first AC voltage; and
the second AC voltage generation circuit includes a second transformer having a primary winding connected to the second switch set and a secondary winding to output an induced voltage as the second AC voltage.

3. The AC power source apparatus as set forth in claim 2, wherein:
the first AC voltage generation circuit includes a first capacitor connected between the secondary winding of the first transformer and the first end of the load; and
the second AC voltage generation circuit includes a second capacitor connected between the secondary winding of the second transformer and the second end of the load.

4. The AC power source apparatus as set forth in claim 2, wherein:
the first AC voltage generation circuit includes a leakage inductance of the primary and secondary windings of the first transformer between the secondary winding of the first transformer and the first end of the load; and
the second AC voltage generation circuit includes a leakage inductance of the primary and secondary windings of the second transformer between the secondary winding of the second transformer and the second end of the load.

5. The AC power source apparatus as set forth in claim 2, wherein:
the first AC voltage generation circuit includes a first winding connected between the secondary winding of the first transformer and the first end of the load; and
the second AC voltage generation circuit includes a second winding connected between the secondary winding of the second transformer and the second end of the load.
